(19) United States
(12) Patent Application Publication
(10) Pub. No.: US 2020/0378509 A1
(43) Pub. Date: Dec. 3, 2020

(54) AIR VALVE FOR AN INFLATABLE DEVICE

(71) Applicant: ZHE JIANG HONG ZHU PLASTIC HARDWARE CO., LTD., Jiashan (CN)

(72) Inventor: Jing-Hong TSAI, Dongguan City (CN)

(21) Appl. No.: 16/428,191

(22) Filed: May 31, 2019

(51) Int. Cl. F16K 15/14

(52) U.S. Cl. CPC F16K 15/144

(57) ABSTRACT

An air valve comprises a valve body having a communicating tube, a flange, and a thread, wherein an airway is formed within the communicating tube, the flange is mounted on and around the communicating tube, and the thread is formed on an exterior surface of the communicating tube. The air valve comprises a supporting member being tubular and embedded in the communicating tube and surrounding the airway. The air valve comprises a cap having a cavity, is screwed with the thread of the communicating tube, and closes one of two opposite ends of the communicating tube. The air valve comprises a valve flap connected to the communicating tube and closing the other one of the two opposite ends of the communicating tube. The air valve comprises a packing ring mounted in the cavity of the cap.

### BACKGROUND OF THE INVENTION

### 1. Field of the Invention

The present invention relates to a valve, and more particularly to an air valve applied to an inflatable device.

### 2. Description of Related Art

Air valves are applied to inflatable devices such as inflatable boats, inflatable pools, or packaging air bags for buffering. In order to fix an air valve to an inflatable device, the air valve is made of a material such as polyethylene or polyvinyl chloride, and the air valve is attached to the inflatable device by high frequency sealing or hot melt adhesive. However, the material of the air valve does not have sufficient stiffness to sustain heavy forces. Leakages commonly happen due to the deformation of the air valve when the air valve is subjected to heavy forces. Particularly a conventional air valve is applied to the packaging air bag for protecting goods during shipment. When air leaks from the air bag via the conventional air valve, the packaging air bag is out of function and cannot protect the goods any longer, pleases reference the patent NO. CN203571155 U and U.S. Pat. No. 6,138,711 A.

To overcome the shortcomings of the conventional air valve, the present invention provides an air valve to mitigate or obviate the aforementioned problems.

### SUMMARY OF THE INVENTION

The main objective of the present invention is to provide an air valve equipped with an inner supporting member to promote rigidity of the air valve and to prevent leakage from the air valve.

An air valve comprises a valve body having a communicating tube, a flange, and a thread, wherein an airway is formed within the communicating tube, the flange is mounted on and around the communicating tube, and the thread is formed on an exterior surface of the communicating tube. The air valve has a supporting member being tubular, embedded in the communicating tube and surrounding the airway. The air valve has a cap having a cavity, is screwed with the thread of the communicating tube, and closes one of two opposite ends of the communicating tube. The air valve has a valve flap connected to the communicating tube and closing the other one of the two opposite ends of the communicating tube. The air valve has a packing ring mounted in the cavity of the cap.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an air valve in accordance with the present invention;

FIG. 2 is an exploded perspective view in partial section of the air valve in FIG. 1;

FIG. 3 is another exploded perspective view in partial section of the air valve in FIG. 1;

FIG. 4 is a perspective view of the valve body of the air valve in FIG. 1;

FIG. 5 is another perspective view of the air valve in FIG. 1;

FIG. 6 is an enlarged perspective view of the supporting member of the air valve in FIG. 2;

FIG. 7 is another enlarged perspective view of the supporting member in FIG. 2; and

FIG. 8 is a cross sectional side view of the air valve in FIG. 1.

### DETAILED DESCRIPTION OF PREFERRED EMBODIMENTS

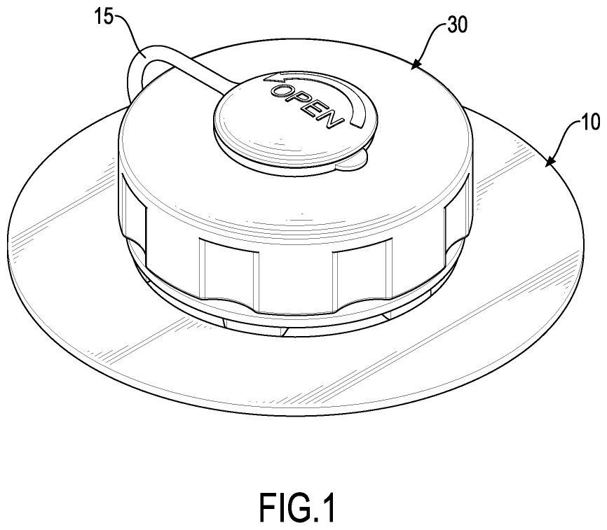

With reference to FIGS. 1 to 3, an air valve of the present invention has a valve body 10, a supporting member 20, a cap 30, a valve flap 40, a fastening unit 50, and a packing ring 60. The supporting member 20, the cap 30, the valve flap 40, and the fastening unit 50 are connected to the valve body 10.

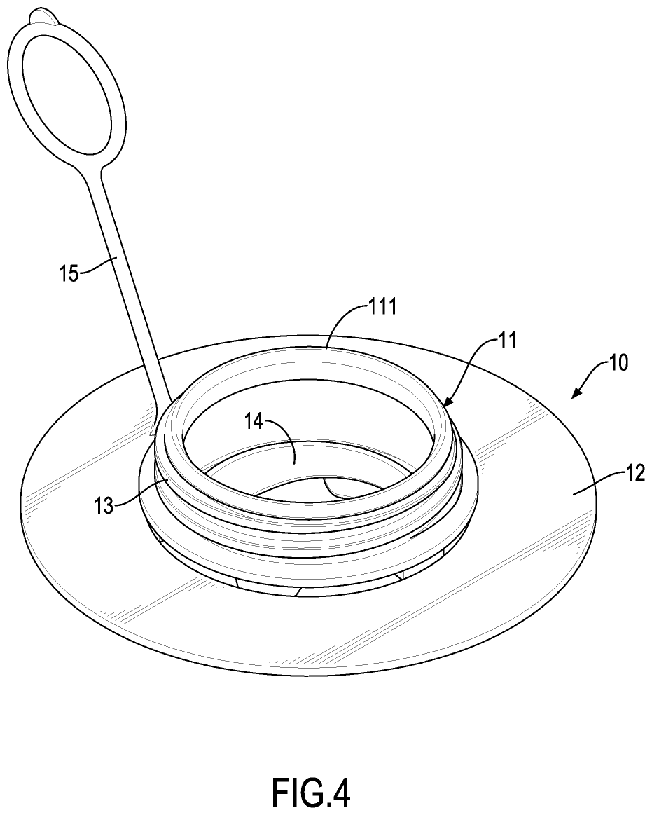

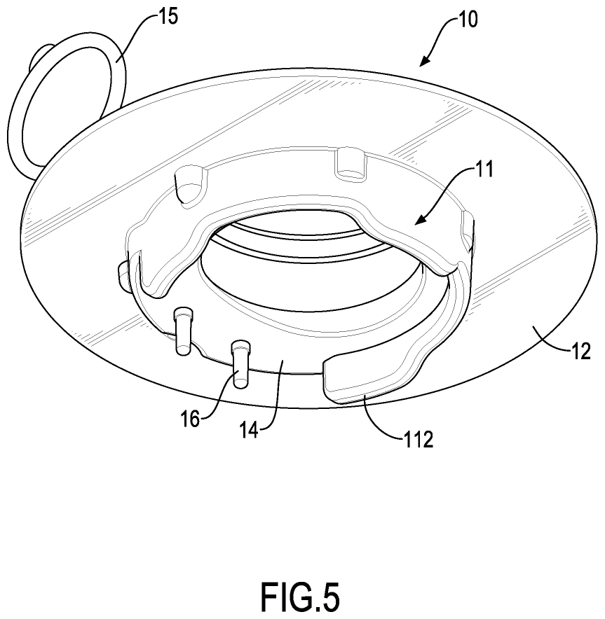

With reference to FIGS. 1 to 5, the valve body 10 has a communicating tube 11, a flange 12, a thread 13, a fastening ring 14, and a connecting strip 15. The communicating tube 11 has a first opening 111, a second opening 112, an interior surface, an exterior surface, an airway, and two opposite ends. The first opening 111 and the second opening 112 of the communicating tube 11 are respectively disposed at the two opposite ends of the communicating tube 11 and are disposed opposite each other. The airway is formed within the communicating tube 11. The flange 12 is mounted on the communicating tube 11. The thread 13 is formed on the exterior surface of the communicating tube 11 at a position between the flange 12 and the first opening 111 of the communicating tube 11. The fastening ring 14 is disposed within the communicating tube 11 and is connected to the interior surface of the communicating tube 11. The connecting strip 15 has two opposite ends. One of the two opposite ends of the connecting strip 15 is integrally connected to the flange 12.

With reference to FIGS. 1 to 3, the cap 30 is connected to the other one of the two opposite ends of the connecting strip 15. The cap 30 has a cavity 31. The cap 30 is capable of screwing with the thread 13 of the valve body 10 and is capable of closing the first opening 111 disposed at one of the two opposite ends of the communicating tube 11.

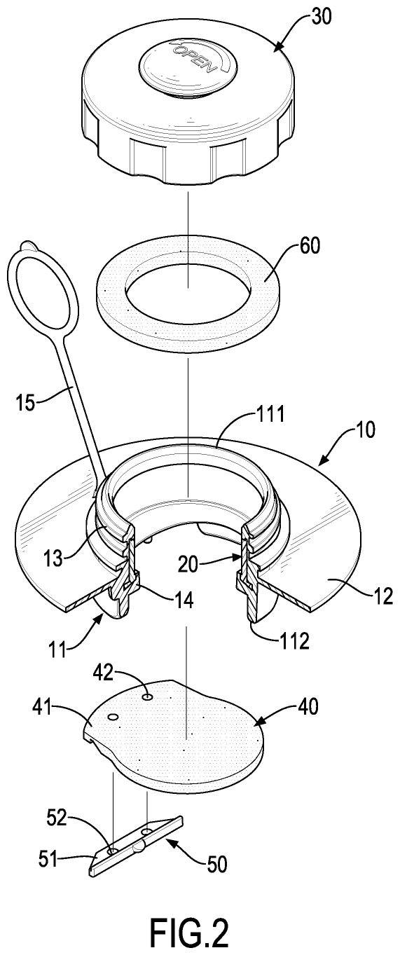

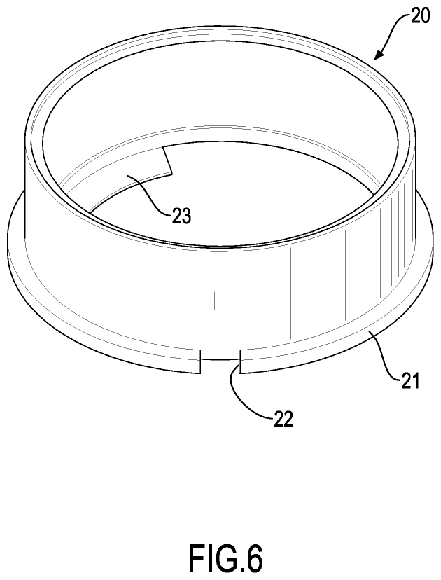

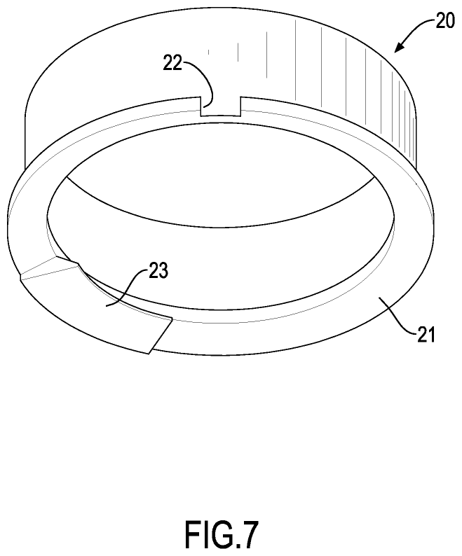

With reference to FIGS. 2, 3, and 6 to 8, the supporting member 20 is tubular and is made of a material that is stiffer than the material that the valve body 10 is made of, such as acrylonitrile butadiene styrene copolymer (ABS). The supporting member 20 has a first end, a second end, an inner surface, an outer surface, an embedding rim 21, and an engaging notch 22. The first end and the second end of the supporting member 20 are disposed opposite to each other. The embedding rim 21 is disposed at the second end of the supporting member 20 and is formed on the outer surface of the supporting member 20. The engaging notch 22 is formed through the embedding rim 21. With reference to FIGS. 6 to 8, in the present invention, the supporting member 20 further has a supporting protrusion 23. The supporting protrusion 23 is disposed at the second end of the supporting member 20. The supporting protrusion 23 is connected to the embedding ring 21 of the supporting member 20, and protrudes inside the supporting member 20.

With reference to FIGS. 2, 3, and 8, the supporting member 20 is embedded in the communicating tube 11 by injection molding. The supporting member 20 is embedded in the communicating tube 11 and surrounds the airway. The first end of the supporting member faces to the first opening 111 of the communicating tube 11 and abuts against the communicating tube 11. The embedding rim 21 is clamped by the communicating tube 11 and the fastening ring 14. The notch 22 formed on the embedding rim 21 by injection molding is engaged with the communicating tube 11 to prevent the supporting member 20 from rotating relative to the valve body 10.

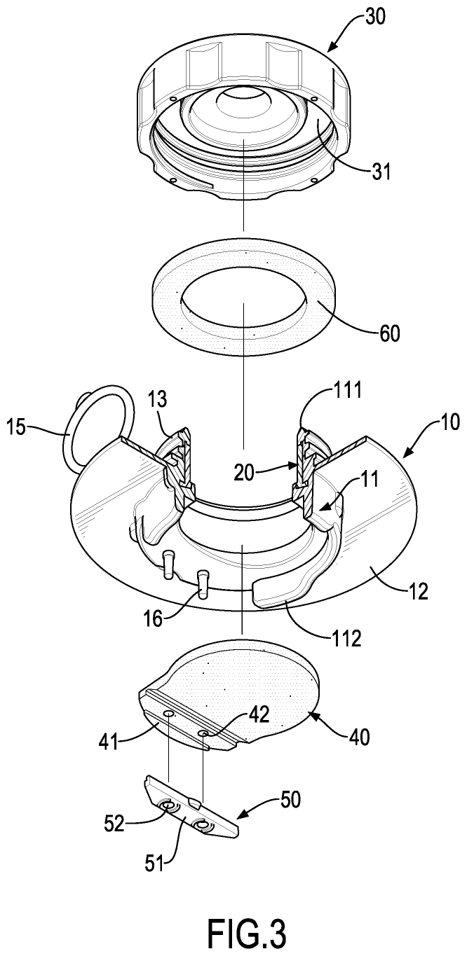

With reference to FIGS. 2 and 3, the fastening unit 50 is connected to the valve body 10, and the valve flap 40 is disposed between the valve body 10 and the fastening unit 50 and is clamped by the valve body 10 and the fastening unit 50. The valve flap 40 is disposed adjacent to the supporting protrusion 23. The fastening unit 50 has a connecting portion 51 with a curved edge in the shape of a cap of a mushroom. The valve flap 40 has a connected portion 41 with a curved edge in the shape of a cap of a mushroom corresponding to the connecting portion 51 of the fastening unit 50.

In the embodiment of the present invention, the valve body 10 has two fastening sticks 16. The two fastening sticks 16 extend from the fastening ring 14 toward the second opening 112 of the communicating tube 11. That is the two fastening sticks 16 are disposed on the fastening ring 14 and extend away from the fastening ring 14. The valve flap 40 has two through holes 42 formed through the connected portion 41 and corresponding respectively to the two fastening sticks 16 in position. The fastening unit 50 has two mounting holes 52 formed through the connecting portion 51. The valve flap 40 is mounted on the two fastening sticks 16 via the two through holes 42. The fastening unit 50 is mounted on the two fastening sticks 16 via the two mounting holes 52 such that the valve flap 40 is clamped by the valve body 10 and the fastening unit 50.

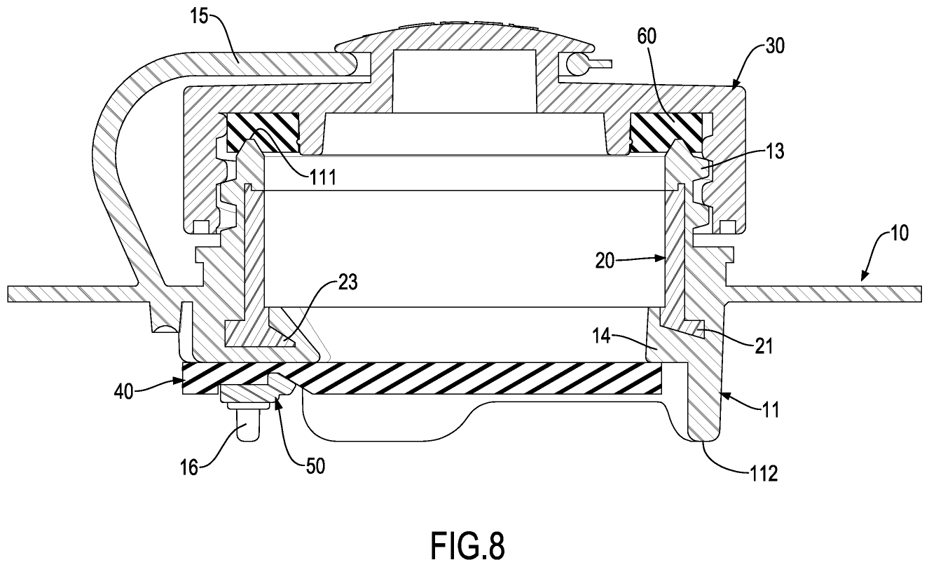

With reference to FIGS. 2 and 3, the packing ring 60 is mounted in the cavity 31 of the cap 30. With reference to FIG. 8, when the cap 30 is screw-threaded to the valve body 10 and closes the first opening 111, the packing ring 60 is clamped by the valve body 10 and the cap 30. The packing ring 60 can prevent the fluid leaking from the first opening 111 of the communicating tube 11 and can prevent leakage from the air valve of the present invention.

Compared to the conventional air valve, the supporting member 20 embedded within the communicating tube 11 provides the communicating tube 11 with better stiffness. The communicating tube 11 with the better stiffness can sustain heavy forces without deformation. When the air valve of the present invention is applied to an inflatable device such as a packaging air bag, the air valve has little chance of leakage even when subjected to heavy forces since the communicating tube 11 is not prone to deformation.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. An air valve comprising:
a valve body having a communicating tube, a flange, and a thread, wherein an airway is formed within the communicating tube, the flange is mounted on and around the communicating tube, and the thread is formed on an exterior surface of the communicating tube;
a supporting member being tubular, embedded in the communicating tube, and surrounding the airway;
a cap screwed with the thread of the communicating tube, closing one of two opposite ends of the communicating tube, and having a cavity;
a valve flap connected to the communicating tube and closing the other one of the two opposite ends of the communicating tube;
a packing ring mounted in the cavity of the cap; and
a connecting strip having two opposite ends;
one of the two opposite ends of the connecting strip integrally connected to the flange;
the other one of the two opposite ends of the connecting strip connected to the cap; and
the supporting member having a supporting protrusion disposed adjacent to the valve flap and protruding inside the supporting member.

2. (canceled)

3. The air valve as claimed in claim 1, wherein
the air valve further comprises a fastening unit, the fastening unit has a connecting portion with a curved edge; and
the valve flap comprises a connected portion with a curved edge corresponding in shape to the curved edge of the connecting portion of the fastening unit.

4. (canceled)

5. The air valve as claimed in claim 1, wherein
the valve body further comprises a fastening ring disposed within the communicating tube and connected to an interior surface of the communicating tube;
the supporting member further comprises a first end, a second end disposed opposite to the first end of the supporting member, and an embedding rim disposed at the second end of the supporting member, formed on an outer surface of the supporting member, and clamped by the communicating tube and the fastening ring.

6. (canceled)

7. The air valve as claimed in claim 3, wherein
the valve body further comprises a fastening ring disposed within the communicating tube and connected to an interior surface of the communicating tube;
the supporting member further comprises a first end, a second end disposed opposite to the first end of the supporting member, and an embedding rim disposed at the second end of the supporting member, formed on an outer surface of the supporting member, and clamped by the communicating tube and the fastening ring.

8. (canceled)

9. The air valve as claimed in claim 5, wherein
the valve body further comprises two fastening sticks disposed on the fastening ring and extending away from the fastening ring;
the valve flap further comprises two through holes formed through the connected portion and corresponding respectively to the two fastening sticks in position, and the valve flap is mounted on the two fastening sticks via the two through holes;
the fastening unit further comprises two mounting holes formed through the connecting portion and corresponding respectively to the two fastening sticks in position, and the fastening unit is mounted on the two fastening sticks via the two mounting holes such that the valve flap is clamped by the valve body and the fastening unit.

10. (canceled)

11. The air valve as claimed in claim 9, wherein the supporting member further comprises an engaging notch formed through the embedding rim.

12. (canceled)
